(19) United States
(12) Patent Application Publication
(10) Pub. No.: US 2008/0081548 A1
(43) Pub. Date: Apr. 3, 2008

(54) Apparatus and Method for Mechanical Removal of Pelt from an Animal Carcass

(75) Inventors: Bruce Edward Muldrew, Otago (NZ); Alan Edward Duthie, Christchurch (NZ); Murray William Miller, Auckland (NZ)

Correspondence Address: YOUNG & THOMPSON, 745 SOUTH 23RD STREET, 2ND FLOOR, ARLINGTON, VA, 22202, US

(73) Assignee: Millers Mechanical (NZ) Limited, Dunedin (NZ)

(21) Appl. No.: 11/663,993

(22) PCT Filed: Sep. 29, 2005
(86) PCT No.: PCT/NZ05/00249

§ 371 Date: Jul. 30, 2007

(30) Foreign Application Priority Data
Sep. 29, 2004 (NZ) 535658

(51) Int. Cl. A22C 17/00

(52) U.S. Cl. 452/128

(57) ABSTRACT

Apparatus for mechanically removing pelt from the carcass of an animal. The apparatus includes a pair of moveable load arms (24) pivotally coupled to a main arm (17). The load arms (24) are locatable one either side of a carcass suspended from a suspension element (16). A clamping mechanism (25) is carried by each of the load arms (24) and is engageable with pelt flaps of a worked up carcass. The load arms (24) are moveable, by an arm cylinder (27), relative to main arm (17). The main arm (17) is moveable by cylinder (19) relative to a frame (11). Thus by moving, via operation of the cylinders (19 and 27), the arms (17, 24) the clamping mechanisms (25) can be moved relative to the carcass. A control unit is operable to control cylinders (19 and 27) whereby the path of movement of the clamping mechanisms (25) relative to the carcass can be varied to suit variations in carcass size and shape.

### BACKGROUND TO THE INVENTION

This invention relates to improvements in method and means for mechanically removing the pelt from an animal carcass.

Mechanical apparatus for removing pelts from animal carcasses are known. One form of such apparatus is to be found in New Zealand patent specification 208963. As disclosed in this patent specification the pelt is removed from the carcass with the carcass suspended by its forelegs. The apparatus has a pair of opposed clamps, each carried by an arm, which is pivotally mounted at a lower end such as to be pivotable about an axis. The clamps each clamp a flap of the worked up pelt in the shoulder area whereupon opposed lateral movement of the arms away from the carcass places a tension on the pelt. After this the arms are pivoted about the pivot axis so that the pelt is peeled from the carcass.

The apparatus disclosed in patent specification 208963 has proved to be successful in the removal of pelt from the carcasses of sheep and other small stock. The apparatus has provided a mechanical means of removing the pelt from the shoulder area to the middle of the back of the carcass. However, a disadvantage of the apparatus is that the fixed travel of the arms means that the apparatus is set up to suit “average” sized animals. As a consequence, correct clearing of the pelt, especially around the neck of the animal may not necessarily occur and thus manual intervention by a worker is needed to rectify any incomplete or incorrect clearing of the pelt from the carcass.

A further feature of the apparatus of patent specification 208963 is that the two worked up skin flaps of the pelt need to be manually loaded into the clamps. Consequently, the apparatus requires an operator to load the skin flaps into the clamps.

### SUMMARY OF THE INVENTION

An object of the present invention is to provide a method for mechanically removing pelt from an animal carcass wherein a variable pull path is employed in order to suit the variability of carcasses.

As second object of the invention is to provide apparatus for mechanically removing pelt from an animal carcass in which a variable pull path is achievable in order to suit the variability of carcasses.

A further object of the present invention is to provide apparatus for removing pelt from an animal carcass in which automatic clamping of worked up flaps of the pelt can take place.

Broadly according to one aspect of the invention there is provided a method of mechanically removing pelt from the carcass of an animal including the steps of clamping in clamping means a worked up part of a carcass suspended from suspension means and causing relative movement to occur between the carcass and the clamping means to clear the pelt from the carcass characterised in that the path of relative movement between the carcass and clamping means is variably controllable to suit variations in carcasses.

Broadly according to a second aspect of the invention there is provided apparatus for mechanically removing pelt from the arms of an animal, the apparatus including a pair of moveable arms locatable one either side of a suspended animal carcass, clamping means carried by the moveable arms, moving means for moving, via said arms, the clamping means relative to the carcass, and control means whereby the path of movement of the clamping means relative to the carcass can be varied to suit the variations in carcasses.

According to a third broad aspect of the invention there is provided apparatus for mechanically removing pelt from the carcass of an animal, the apparatus including a pair of moveable arms locatable one either side of a carcass suspended from suspension means, clamping means carried by each of the arms and engageable with pelt flaps of a worked up carcass, moving means for moving, via said arms, the clamping means relative to the carcass, and control means whereby the path of movement of the clamping means relative to the carcass can be varied to enable the clamping means to be positioned under the pelt flaps of different sized carcasses, said control means being arranged to cause the clamping means to clamp said pelt flaps.

### BRIEF DESCRIPTION OF THE DRAWINGS

In the following more detailed description of the invention reference will be made to the accompanying drawings in which:

FIG. 1 is a perspective view of the apparatus,

FIG. 2 is a side elevation view of the apparatus, and

FIGS. 3-8 are similar side elevation views showing the configuration of the apparatus at various points in a pull path as pelt is removed from the carcass.

### DESCRIPTION OF PREFERRED EMBODIMENTS OF THE INVENTION

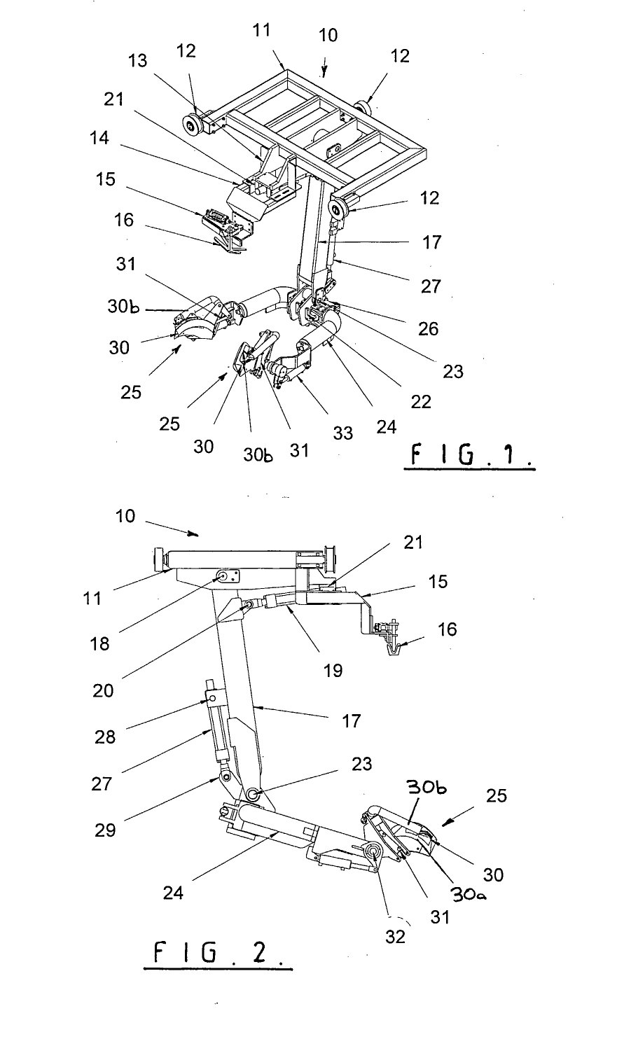

Referring firstly to FIG. 1, the pelt removal apparatus 10 is seen to include a moving frame or trolley 11, which has strategically positioned wheels 12 which can run on rails (not shown). Thus, the removal apparatus 10 can be integrated in an animal processing line so as to move on the rails alongside the processing line so as to be able to move in a synchronised manner with the processing line.

The moving frame 11 includes a front sub-frame in the form of support plates 13, which includes an outwardly projecting member formed by a pawl arm support 14. At the distal end of the pawl arm support 14, there is a pawl arm 15, which engages a narrow spreader or hock holder 16 (part of a moving conveyor) into which the forelegs of the carcass are engaged. Consequently, the carcass hangs from its forelegs and the carcass and the pelt removal apparatus 10 moves together.

A downwardly depending main arm 17 is pivotally coupled at its upper end to the rear of the moving frame 11. The main arm 17 is thus able to pivot about a top pivot 18 as will hereinafter become evident.

A linear actuator, preferably in the form of a hydraulic cylinder 19, is connected between mounting on main arm 17 which provides a cylinder top pivot 20 and a forward or trunion mount 21, which is coupled to the moving frame 11 in the vicinity of the support plates 13. In the illustrated form of the invention the body of the cylinder 19 is coupled to trunion mount 21 and the outer end of the piston rod is coupled to the cylinder top pivot 20.

Carried at the lower end of the main arm 17 is a mount or pivot housing 22, which is pivotally coupled via main arm bottom pivot 23 to the lower end of the main arm 17. This pivot housing 22 carries a pair of load arms 24. At the distal end of each load arm 24 is a clamp mechanism 25.

The ends of the load arms 24 mounted with pivot housing 22 are mounted in such a manner that via the operation of a hydraulic ram or spread cylinder 26 the load arms 24 can move from the position shown in FIG. 1 away from each other for a distance. The movement occurs at the beginning of the pelt removal operation to tension the pelt in the manner disclosed in NZ 208963.

The load arms 24 can also pivot about the axis of main arm bottom pivot 23 via the action of a hydraulic ram or lower arm cylinder 27. Cylinder 27 is mounted between a mounting or lower arm trunion 28 carried by main arm 17 and a connecting piece 29 forming a pivot housing cylinder pivot which is coupled to the pivot housing 22.

As will be appreciated by those skilled in the art, the clamp mechanisms can take different forms. The main criteria is that each mechanism can clamp a worked up flap of the pelt.

In the illustrated form of the invention, and by way of example, the clamp mechanism can be formed by a pair of clamps 30, which via the action of a hydraulic ram (clamp cylinder) 31 are able to move toward each other into a clamping position and away from each other to an unclamping position. The clamped position is shown in FIG. 1.

The clamps 30 can, as illustrated, be a first clamp element 30a and a clamp arm 30b. Under the action of the clamp cylinder 31 the clamp arm 30b can be moved to a position where the distal end is spaced from the clamp element 30a. Into this space can be located the flap of the pelt whereupon the clamp arm 30b can move back into the clamping position to clamp the flap between the distal end and the clamp element 30b.

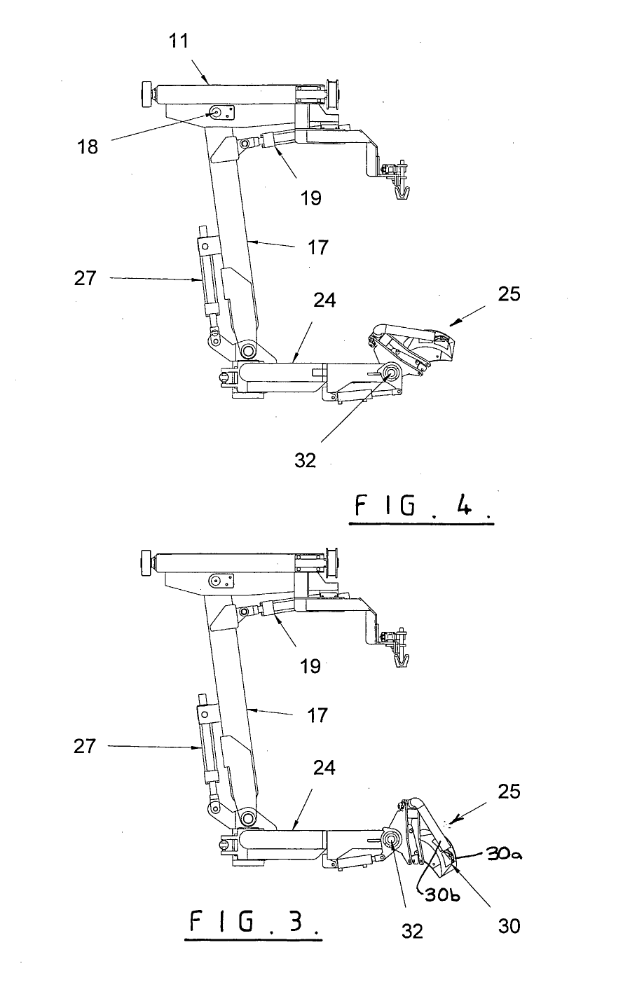

The clamps 30 are furthermore pivotally mounted via clamp pivot 32 to the load arms 24. A small hydraulic ram (tilt cylinder) 33 is operable to pivot the pair of clamps 30 about clamp pivots 32 as is shown in FIGS. 3-8. This is one preferred form, however, it is possible that in another form the provision for the clamp mechanism 25 to pivot on the load arm 24 may not be part of the construction.

To more fully describe the invention reference will now be made to the pelt removal apparatus in operation according to one mode of operation to achieve a pull path.

In its preferred form the apparatus incorporates an auto-loading facility. However, it will be appreciated that the essence of the invention is the variable pull path, which will hereinafter be described. Therefore, equally the apparatus could include manual pelt clamps, though in the preferred form of the invention, automatic load clamps are included as these require no manual intervention.

With a carcass suspended from the spreader 16, the automatic load system is activated. It will be appreciated by those skilled in the art that the control of the mechanical elements of the apparatus and the operational steps will be under PLC control.

With the automatic load system activated the load arms 24 with the clamps 30 in the unclamped position, are moved up by actuation of load arm cylinder 27 to make contact with a carcass on each side. The inner clamps 30 make contact with a respective side of the carcass. The load arms 24 rise up and when positioned under the cleared shoulder flaps of the pelt, the clamping mechanism 25 is operated by clamp cylinder 31 so that the shoulder flaps are clamped between the respective pairs of clamps 30. Consequently, the pelt is clamped to the apparatus and the pelt removable sequence can commence.

At the completion of the pelt removal the load arms 24 return via a different path (as will hereinafter become evident) and the clamp mechanisms 25 release. The machine then returns to a rest position ready to receive the next carcass.

It will be appreciated that the overall shoulder pull up operation of gripping the pelt, spreading and pulling back, is essentially in accordance with the operational steps disclosed in NZ 208963. However, the arrangement of the pelt removal apparatus according to the present invention is such that the arc of travel of the load arms 24 can be varied. For example, it has the ability to lift the pelt flaps after gripping by clamp mechanisms 25 to correctly clear the pelt around the neck region of the carcass. Within an envelope of all possible movements, infinite pulling paths are possible. This also allows for a different independent return path of the load arms.

The variable pull path is created by the action of the two hydraulically activated load arms 24 operating in a single plane.

The load arm cylinder 27 which controls movement of the load arms 24 and the spreader cylinder 26 for spreading the load arms 24, have integral linear sensors to provide a full PLC closed loop system for positioning. The central control unit for the apparatus comprises two PLC units. A system PLC unit controls the ancillary movements i.e. movement of the moving frame 11 and the spreading action achieved via operation of spreader cylinder 26. The second PLC unit (a so-called MSC unit) controls the removal of the pelt. Consequently, the MSC unit is operable to drive the main cylinder 19, load arm cylinder 27 and tilt cylinder 33 so that the clamp mechanisms 25 holding the pelt flaps follow a particular path chosen to remove the pelt. At all stages feedback from the position sensors associated with these cylinders 19, 27 and 33 confirm the arm movement.

As a consequence, paths can be chosen which will be either manually set or automatically set based on carcass size. In the latter arrangement, the carcass size can be determined by a light beam or similar system before the carcass reaches the pulling apparatus 10. The following will therefore describe, with reference to FIGS. 2 to 8, a possible sequence of movements of the clamp mechanisms 25, load arms 24 and main arm 17. However, it is stressed that this is by way of example of one of many variations that are possible by the PLC control of the controlling elements (e.g. cylinders 19, 27 and 33).

Referring to FIG. 2, the “rest” position of the apparatus is shown. This is the position in which the apparatus 10 will be when a new carcass with worked up pelt presenting flaps in the brisket area, is presented to the apparatus 10.

FIG. 3 shows the load arms 24 fully raised by operation of load arm cylinder 27 whereby the clamp mechanisms 25 become located with clamp elements 30a under the flaps on each side of the carcass and clamp arm 30b adjacent the outer surface of the flaps.

FIG. 4 shows the load arms 24 once again in the fully raised position but ready for the clamping operation by tilting the clamp mechanisms 25,(relative to the load arms 24) via operation of the tilt cylinder 33. In this orientation each flap becomes clamped between the respective clamps element 30a and clamp arm 30b by the clamp arm 30b being moved toward the clamp element 30a. The clamp mechanisms 25 thus clamp the flaps between the respective pairs of clamp elements 30a and clamp arms 30b.

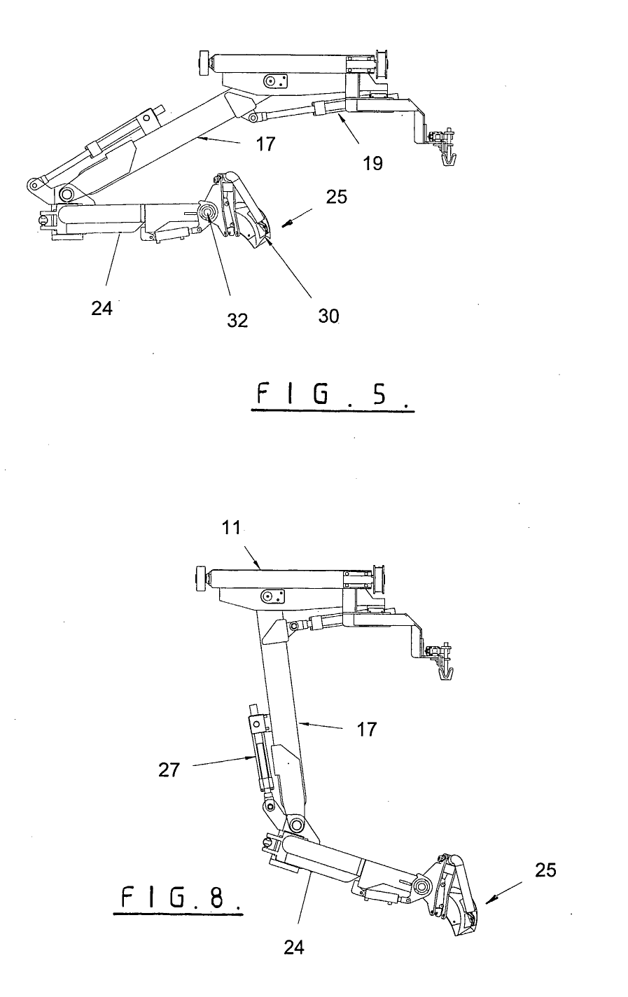

FIG. 5 shows the apparatus in the initial stages of pelt removal where the main arm 17 under action of main arm cylinder 19 has been moved rearwardly i.e. away from the carcass but with the orientation of the load arms 24 and clamp mechanisms 25 maintained substantially in a constant orientation relative to the carcass (i.e. generally horizontal) by actuation of the load arm cylinder 27.

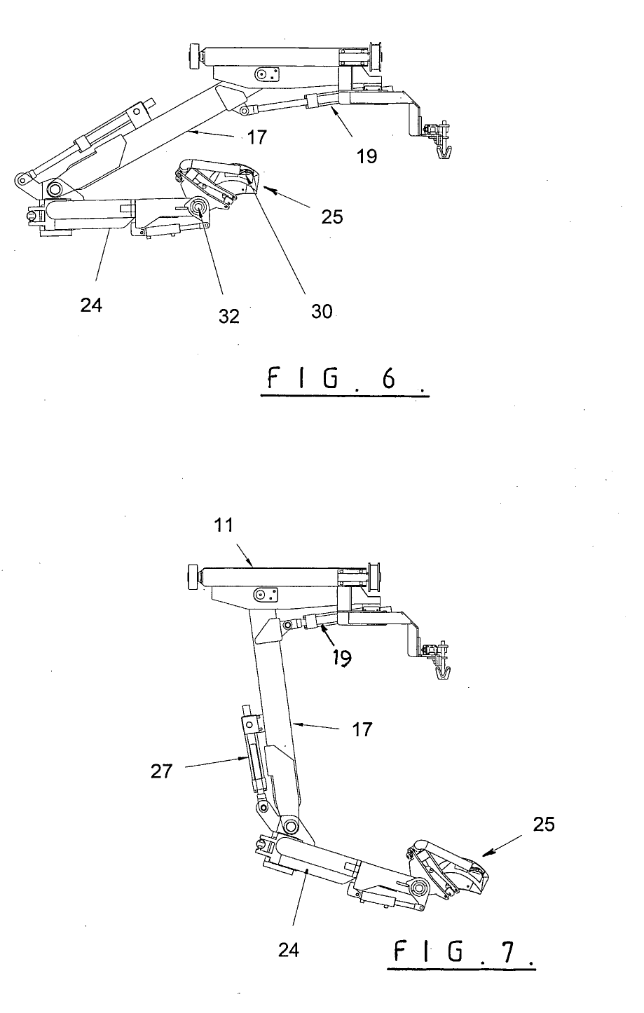

FIG. 6 shows the orientation of the apparatus when the pelt has been cleared from the neck and immediate shoulder portion of the carcass. It will be observed that in this orientation the clamp mechanisms 25 have been tilted up by the tilt cylinder 33. The load arm cylinder 27 then commences retraction which causes the load arms 24 to pivot relative to the main arm 17 and thus move downwardly. Also, the main arm cylinder 19 retracts to pivot the main arm 17 relative to the moving frame 11. The combined result is a pulling action on the pelt to pull the pelt down to the top of the biceps femoris or middle back region of the carcass. This completes the extent to which the pelt is pulled from the carcass. The apparatus thus operated takes up the configuration shown in FIG. 7.

Following this movement being completed the clamp mechanisms 25 are tilted to the position shown in FIG. 8 and operated to release the pelt to thereby complete the pelt pulling operation.

The present invention thus overcomes problems associated with the apparatus as disclosed in NZ 208963 as control of the various cylinders 19, 27 and 33 enables the pull path can be varied as may be required for a correct clearing action for the size of carcass etc. Not only does this enable the apparatus to adopt a pull path commensurate on the size of the carcass, but also enables the pull path to be optimised in order to correctly clear the pelt from the neck area.

The secondary feature of the automatic loading of the pelt flaps into the clamps provides a further improvement in that manual intervention to clamp the pelt flaps is not required.

While the above description relates to a preferred embodiment of the invention it is to be understood that operations and modifications may be made to the preferred form of the invention as will be apparent to those skilled in the art and/or such modifications and alterations are intended to be and included within the scope of the present invention as defined by the following claims.

1-20. (canceled)

21. A method of mechanically removing pelt from the carcass of an animal including the steps of clamping in a clamping mechanism a worked up part of a carcass suspended from a support and causing relative movement to occur between the carcass and the clamping mechanism to clear the pelt from the carcass characterised in that the path of relative movement between the carcass and clamping mechanism is variably controllable to suit variations in carcasses.

22. Apparatus for mechanically removing pelt from the carcass of an animal, the apparatus including a pair of moveable arms locatable one either side of a carcass suspended from a support, a clamping mechanism carried by each of the arms and engageable with pelt flaps of a worked up carcass, moving mechanism for moving, via said arms, the clamping mechanisms relative to the carcass, and control device whereby the path of movement of the clamping mechanisms relative to the carcass can be varied to enable the clamping mechanisms to be positioned under the pelt flaps of different sized carcasses, said control device being arranged to cause the clamping mechanisms to clamp said pelt flaps.

23. Apparatus as claimed in claim 22 wherein the arms are pivotally coupled to the support which depends from a support frame.

24. Apparatus as claimed in claim 23 wherein the support frame is adapted for moveable mounting on a rail structure, said support frame including a mounting arrangement for a holder element for suspension of a carcass.

25. Apparatus as claimed in claim 24 wherein the support has an upper end which is pivotally coupled to the support frame and a lower end at or adjacent to which is pivotally coupled the arms.

26. Apparatus as claimed in claim 25 further including a first moving device coupled to the support and operable to control pivotal movement of the support relative to the support frame.

27. Apparatus as claimed in claim 26 wherein the first moving device is a linear actuator coupled between the support and support frame.

28. Apparatus as claimed in claim 26 further including a second moving device coupled to the arms and operable to pivotally move the arms relative to the support.

29. Apparatus as claimed in claim 28 wherein the second moving device is a linear actuator coupled between the support and a mount to which the arms are coupled, said mount being pivotally coupled to the support to form the pivot coupling of the arms to the support.

30. Apparatus as claimed in claim 29 wherein the arms are pivotally coupled to said mount whereby the arms can be moved to cause the clamping mechanisms to be moveable transverse to the carcass, there being a third moving device coupled between the mount and the respective arm and operable to effect pivotal movement of the arms relative to said mount.

31. Apparatus as claimed in claim 30 wherein the clamping mechanism is pivotally coupled to the arm.

32. Apparatus as claimed in claim 31 wherein a clamp moving device is coupled between the arms and the clamping mechanism and operable to tilt the clamping mechanism relative to the arm.

33. Apparatus as claimed in claim 33 wherein the clamp moving device is a linear actuator.

34. Apparatus as claimed in claim 31 wherein each clamping mechanism includes a clamp element, a clamp arm and a clamp operator whereby, in use, controlled relative movement between the clamp element and clamp arm can occur.

35. Apparatus as claimed in claim 34 wherein the control device is arranged to control operation of the first and second moving devices, and the clamp operator.

36. Apparatus as claimed in claim 35 wherein the control device is one or more PLC controllers programmed to control the first and second moving devices to achieve the path of movement of the clamping mechanism.

37. Apparatus as claimed in claim 36 wherein the control device is also arranged to control the clamp moving device.

38. Apparatus as claimed in claim 36 wherein the control device is also arranged to control the clamp operator.

39. Apparatus as claimed in claim 37 wherein the control device is also arranged to control the clamp operator.
